(19) United States
(12) Patent Application Publication
(10) Pub. No.: US 2009/0030952 A1
(43) Pub. Date: Jan. 29, 2009

(54) GLOBAL ASSET MANAGEMENT

(76) Inventors: Michael J. Donahue, Brockport, NY (US); Mark D. Wood, Penfield, NY (US); Samuel M. Fryer, Fairport, NY (US); Gary Marzec, Churchville, NY (US)

Correspondence Address: Frank Pincelli;Patent Legal Staff, Eastman Kodak Company, 343 State Street, Rochester, NY, 14650-2201, US

(21) Appl. No.: 11/776,199

(22) Filed: Jul. 11, 2007

Related U.S. Application Data
(60) Provisional application No. 60/830,241, filed on Jul. 12, 2006.

(51) Int. Cl. G06F 12/16; G06F 17/30

(52) U.S. Cl. 707/203; 707/201; 707/E17.005

(57) ABSTRACT

A system and a method for managing data among devices, servers and systems by providing a logically unified and aggregated view of a user's digital assets including metadata from any system node or device. This invention describes a method supporting the aggregated view by using manifests. A manifest is a file/database that includes data about all media assets within a user's virtual collection.

### CROSS-REFERENCE TO RELATED APPLICATIONS

This is a 11A Application of Provisional Application Ser. No. 60/830,241, filed Jul. 12, 2006

### FIELD OF THE INVENTION

The present invention relates to the architecture, services, and methods for managing data among devices, servers and systems. Specifically, the present invention relates to providing a logically unified and aggregated view of a user's digital assets including metadata from any system node or device.

### BACKGROUND OF THE INVENTION

Digital assets include images, videos, and music files which are created and downloaded to personal computer (PC) storage for personal enjoyment. Typically, these digital assets are accessed when needed for viewing, listening or playing. Various devices and internet services provide and utilize these assets including Personal Digital Assistants (PDAs), digital cameras, personal computers (PCs), media servers, terminals and web sites. Collections of assets stored on these devices or service providers are generally loosely coupled and current synchronization processes occur typically between 2 devices, for instance a media player and a PC. Problems with this environment of loosely coupled devices and services are digital asset accessibility by any device or service, needing to maintain multiple logins, asset synchronization, disorganization and data loss. Existing technology found within various distributed database systems and specialized synchronization programs have attempted to solve these problems with varying degrees of success.

### SUMMARY OF THE INVENTION

The object of this invention is to solve several of the above mentioned problems by providing for an aggregated (across 1 or many nodes) view and access of all media assets owned and shared. All of the digital/media assets owned or shared by a user is called a user's virtual collection. This invention describes a method supporting virtual collections using manifests. A manifest is a file/database that includes data about all media assets within a user's virtual collection. A system architecture that supports virtual collections is defined including several methods for creating and maintaining a virtual collection.

Another aspect of this invention are the data structures, asset ids, and organization supporting virtual collections. These mechanisms have been designed for excellent performance in light of the growing number of digital assets and devices in a user's media ecosystem. Version vectors are a well known technique for replicating databases that have been applied in a unique way to manage virtual collections.

Another aspect of this invention include simple and efficient methods for adding a device/collection and removing a device/collection to a user's virtual collection. In addition, the architecture and system provides improved methods for recovery of lost data and for automatic redundancy across devices to improve reliability and availability. Automatic archiving of media assets that are stored across multiple devices, and keeping track of CD/DVD name and contents, and providing automatic incremental updates are all enabled by this system.

### BRIEF DESCRIPTION OF THE DRAWINGS

FIG. 1—User's Media Ecosystem

FIG. 2—System Architecture

FIG. 3—Components for Reconciliation of Virtual Collection

FIG. 4—Components for Asset Repository management

FIG. 5—XML Manifest

### DETAILED DESCRIPTION OF THE INVENTION

The invention has been described in detail with particular reference to certain preferred embodiments thereof, but it will be understood that variations and modifications can be effected within the spirit and scope of the invention.

### Definitions

Asset—Digital file that consists of a picture/still image, a movie/video, audio, or multimedia presentation. Numerous standard formats exist for each type of asset.
Owner—Every asset has an owner. Owners are responsible for organizing and managing their assets. Owners may allow others to view or even modify the objects that they own, but they are solely responsible for controlling access and otherwise managing owned assets.
Collection—The entire set of images and other assets visible to a person.
Personal collection.—The set of assets owned and managed by a person is known as their personal collection. Some of these assets may be shared with other individuals, in which case they become part of those individuals extended collections. They would still be considered part of the owner's personal collection.
Extended collection—The total set of assets accessible by a person, owned or otherwise, including those which other people or groups have shared with them, is known as their extended collection
Managing a collection—The owner of a collection has the ability to organize or otherwise rearrange the logical view of the contained assets to suit their own personal tastes. A manager has the additional responsibility of granting varying degrees of access to others for the purposes of sharing.

### GAM—Global Asset Management

Rendition—An internal representation of an image generated and maintained transparently to users intended to present an illusion of sameness (e.g., the system will decimate an image to present a similar view on a lower resolution device). This is for the system's convenience.

### Overview

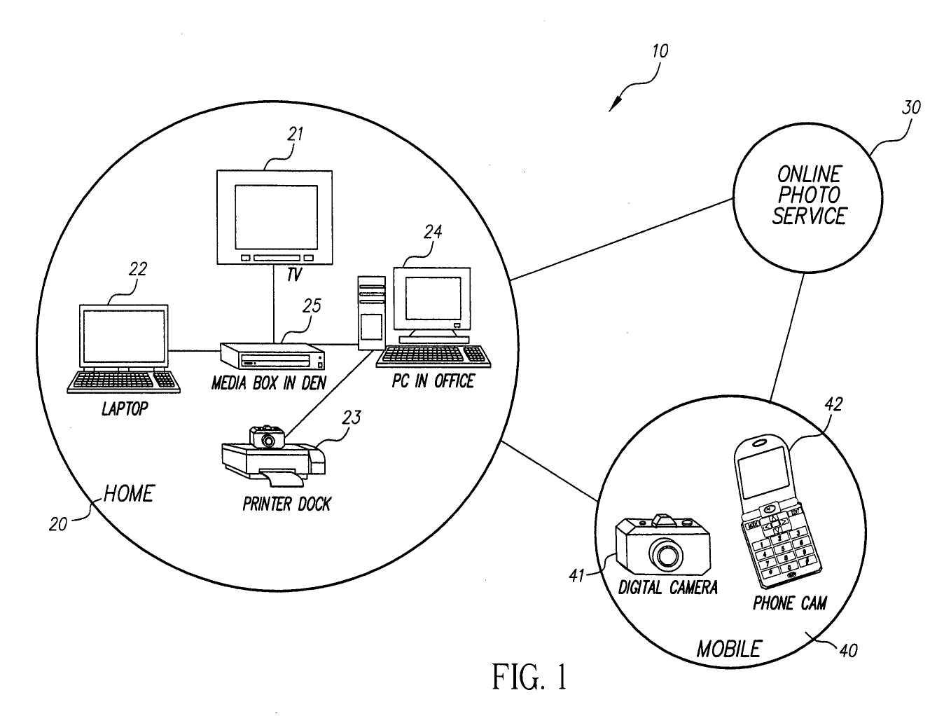

With the advent and popularity of digital photography, users have been taking and using digital pictures and videos in increasing numbers and ways. Numerous devices, systems, networks and services have been created and have established what can be referred to as the user's media ecosystem. FIG. 1 illustrates the components of the user's media ecosystem 10 that includes three major hubs or nodes: user's home media environment 20, online photo services 30, and mobile devices 40. The user's home media environment 20 includes media devices and networks that are typically found in the home including a television 21, a home office PC 24, a laptop computer 22, a printer 23, and a media box 25. The media box 23 typically is connected to the television 21 and provides cable TV channels for viewing. The media box 23 may also be part of a home network that enables media assets that are stored on a home PC 24 or laptop computer 22 to be viewed on the home television 21. Another major node of the user's media ecosystem 10 includes online photo services 30 that are accessed via the internet. The home media environment 20 typically can connect to the internet via a broadband or dial-up connection. Users may access the online photo service 30 of choice via a PC where digital assets may be uploaded, stored on an online photo service 30 server, printed as part of a variety of output products and electronically shared with other users via the internet. Mobile devices 40 constitute the third major node of the user's media ecosystem 10 and include mobile devices such as digital cameras and camera phones. The devices allow users to be located anywhere to take and view pictures. These mobile devices often times provide a method of communication to the devices in the user's home media environment 20 and to the online photo service 30. The camera phone can connect to the online photo service via a wireless connection to the phone service that bridges the data to the online photo service 30. Within the user's media ecosystem 10, a user may have several devices where digital assets may be stored and accessed. The invention provides an automated and distributed system where consumers can access, view, modify, and use assets from their collection at any time and from any participating node in the system, without specific knowledge of which node those assets reside on or how to retrieve them. This system will be referred to as the Global Asset Management (GAM) system. Users possess digital assets (images, videos, etc.) that exist on one or more computers, home appliances, mobile devices, or online services. In the preferred embodiment, the GAM system presents the paradigm of a logically unified, aggregated view or “virtual collection,” consisting of the metadata for all the assets of which a user is aware. In alternative embodiments, it may be useful for the virtual collection to consist of the metadata for just a subset of all the assets; this may be desirable if the collection is very large. The GAM system is an automated distributed system where users can access, view, modify, and use the assets from their virtual collection at any time and from any participating node in the system, without specific knowledge of which node those assets reside on or how to retrieve them. It provides three basic functions: access, aggregation, and persistence. Access refers to the ability to view digital assets and related metadata located on remote, connected nodes. Aggregation refers to the ability to blend views of distributed assets into a single “virtualized” view of an entire collection independently of physical asset distribution. Persistence refers to the ability to retain a memory of this virtualized view as connections change and nodes connect and disconnect.

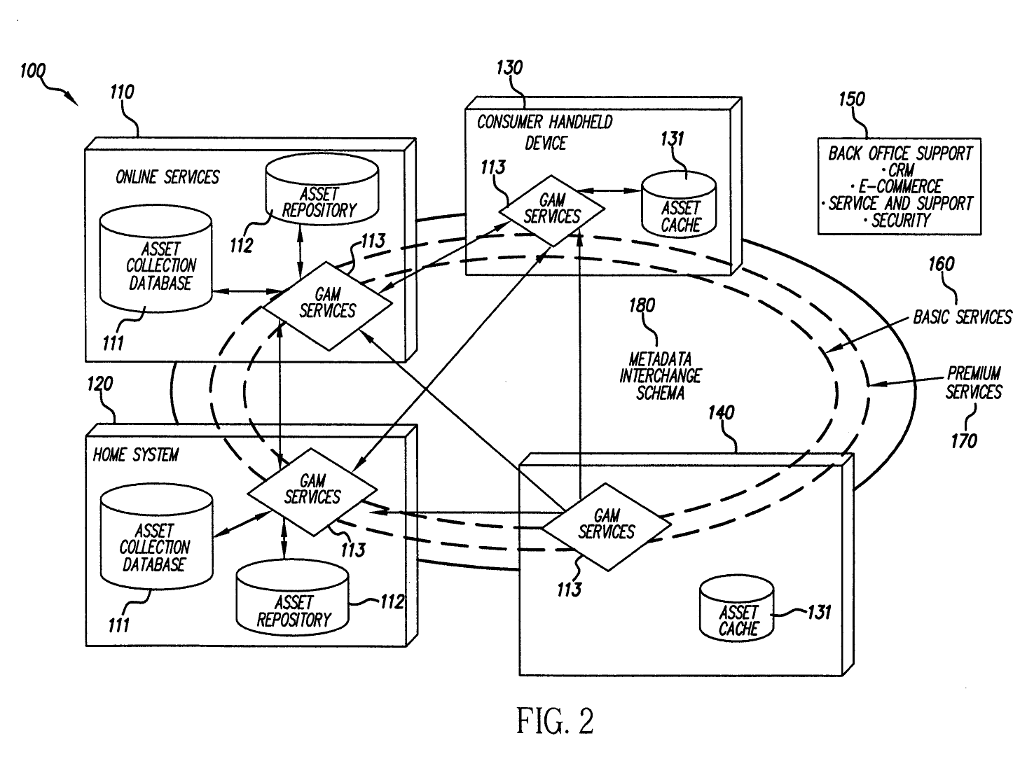

FIG. 2 illustrates the system architecture 100 for the Global Asset Management Photo System. The online services 110 node includes an asset repository 112, an asset collection database 111, and a set of GAM services 113. The asset collection database 111 is the data structure that contains all information necessary to locate a users set of images. It does not contain the images themselves, which are either in an asset repository 112, or cached 113 on a device. The asset collection database 111 maintains user profile information, maintains a map to locate digital assets within the distributed asset repository, maintains user views that present the digital assets in the form of various containers. The asset repository 112 is the physical, persistent storage for digital assets. All of the images in the asset repository are referenced in the asset collection database 111. An asset repository 112 may consist of a simple file system, or another external data store, which is accessed through, for example, standard OS level mechanisms. The asset cache 131, which is temporary storage of digital assets which has been selectively populated by the GAM connection service to reduce latency and generally facilitate easy access on a particular device. Cached images are not tracked in the asset collection database 111.

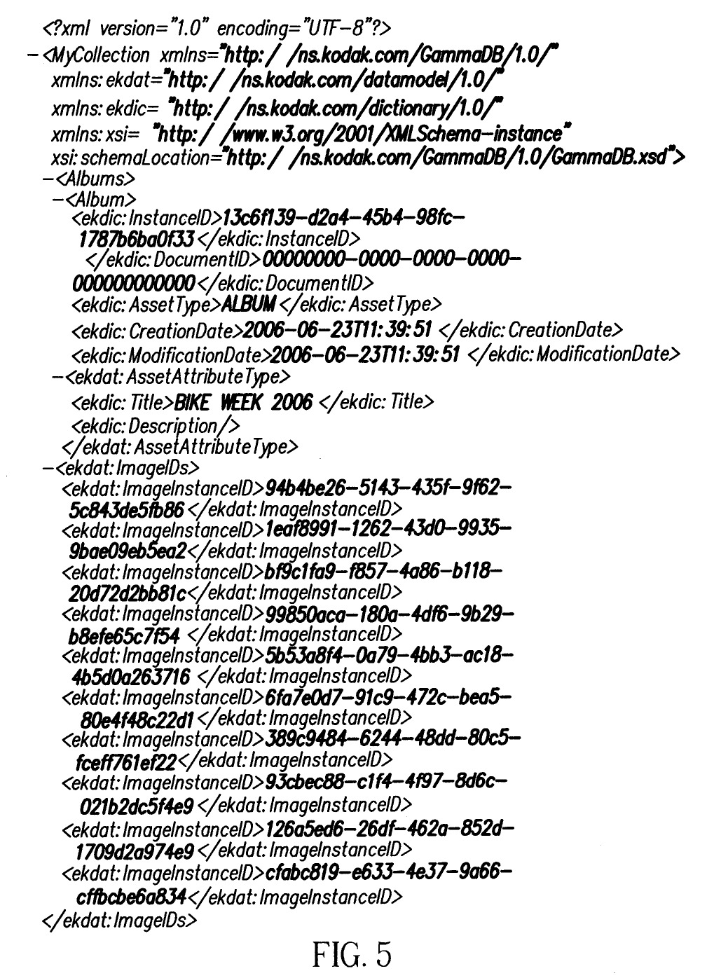

The directory structure of a collection on a local node may be implemented within the file system, as well as with a database. The knowledge about a collection is itself an asset called a manifest that can be exchanged between nodes. A manifest describes the container objects (e.g., albums, events) that organize the collection content and references the asset items (e.g., images, videos) that are associated with each container, allowing an application to manipulate (e.g., retrieve, copy) the digital content of the container. Manifests may be encoded using an open standard (e.g., MPV, DIDL-Lite) to allow content to be defined and communicated among different products. FIG. 5 provides an XML listing of a sample manifest file.

In an alternate embodiment, a node may present all node manifests as separate partitions (i.e., not as an aggregated whole). Secondly, a node does not need to integrate the manifest from another node into its local collection (i.e., not persistent) because the partition for that other node is presented only as long as there is a network connection to it.

In addition, communities of users will be supported by the concept of “sharing groups.” Sharing groups will be handled within a GAM system as though they were a virtual person. Permission to access assets may be granted to a group similarly to granting access to individuals.

Connectivity between these nodes will vary, some being connected most of the time (“online”) and some rarely (“nearline”). Some assets tracked by the system may be in archives or other “offline” places or media. The GAM system provides maximal access to virtual collections in all cases.

In addition to simply viewing asset collections, users will want to manipulate them in various connection states. They will change them, reorganize them, and share them with others. They also want to archive individual or groups of assets by copying them to removable media while retaining a reference to them in the permanent record. Some users will take advantage of the location transparency of the system, while others will want to explicitly manage asset location by migrating assets between nodes for backup, immediacy, or other reasons. The GAM system tracks digital assets as they undergo these changes, and is able to consistently and intelligently propagate these changes through the entire system.

Major components of this system include the Connection Service which is responsible for monitoring the GAM environment, recognizing cooperating nodes, and sharing data with them. It is responsible for sharing GAM database updates, moving images and other assets, and generally providing a “back end” service as needed to support the sharing model. The GAM connection service will be responsible for publishing a particular node's characteristics and capabilities to partners during device discover.

A GAM system includes several components which will be described in detail. One essential function of a GAM system is the exchange of manifests between nodes. In order to access the content directory of remote nodes, a reconciliation service returns a remote node's manifest. The metadata in a manifest may be encoded via an open standard which facilitates interchange. The applications are not required to add the content of other nodes to their content but are capable to present a partitioned view of the content that is distributed within the home.

The GAM system is capable of providing a common directory structure for the content on all nodes (i.e., an aggregated view). This common directory structure could reside in a file (i.e., like a manifest) or in an application database. In addition, all nodes of a GAM system may reconcile their content as changes are made anywhere in the home environment and to remember (i.e., persist) the effects of those changes.

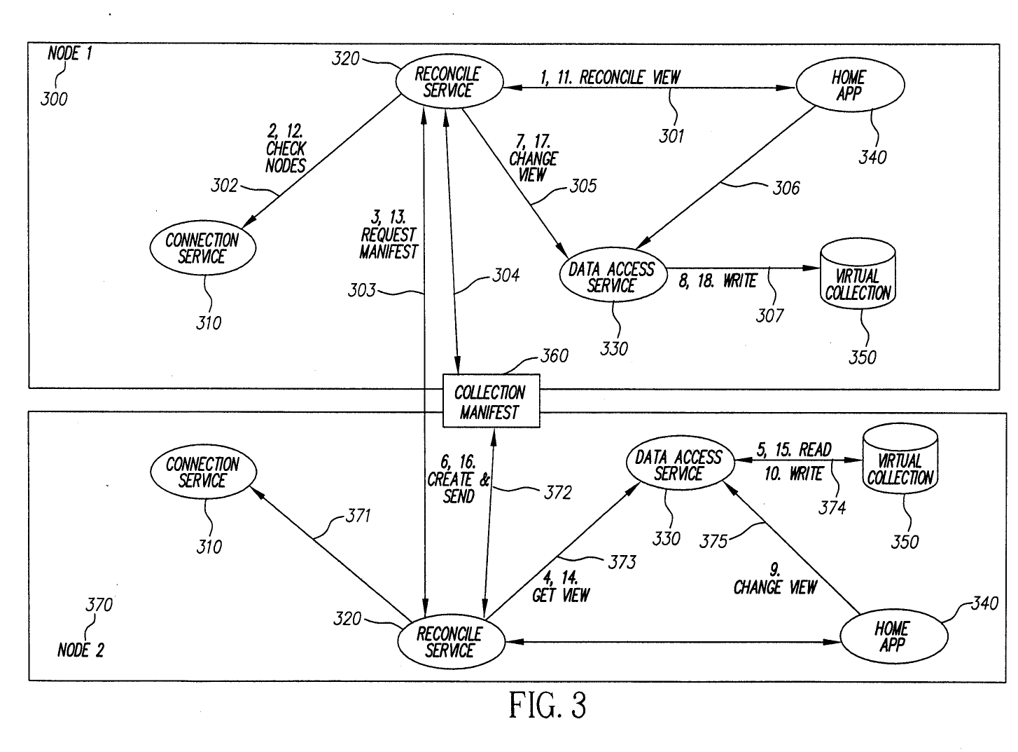

FIG. 3 depicts, at a conceptual architecture level, the GAM system components that interact and the sequence of messages that are exchanged in order to realize an aggregated and persistent view of home content via manifest reconciliation. The reconcile service 320 may acquire the virtual collection 350 as known on a remote node by interchanging a manifest 360. Therefore, rather than just providing the manifest to the application 340 as content in a partitioned view, the reconcile service encapsulates the logic for interpreting and resolving the versions of the manifest. To this end, the reconcile service allows an application to reconcile its view of the virtual collection with that of other nodes in the home, at startup and on a periodic schedule by polling the remote node. For a node that is initiating reconciliation (messages 301,302,303), it sends a request for another node's manifest, receives another node's manifest, decodes the manifest it received, resolves the differences between its manifest and the decoded manifest it received, and uses the data access service to update its version of the virtual collection appropriately. For a node that is responding to manifest requests (while it may also be initiating reconciliations with other nodes), it receives a request for its manifest, accesses its version of the virtual collection, encodes its manifest (messages 372), and sends its encoded manifest.

The data abstraction layer is called by the application to reflect local changes in its version of the virtual collection. It is also called by the reconcile service to reflect changes on other nodes received via their manifests. To this end, the data access service provides a set of accessors that allow a node to read the metadata associated with the virtual collection (messages 373, 374) and provides a set of mutators that allow a node to modify the metadata associated with the virtual collection (messages 305,307,375,374),

If the virtual collection on a node is the application database, then the application could access the database directly to reflect local changes.

To improve the efficiency of the information exchange between nodes of a GAM system, an algorithm using version vectors may be used. The size of the manifests being interchanged will increase as the number of assets in a virtual collection grows. Network bandwidth in the home may throttle the movement of entire manifests to the point of visible performance degradation. Entire manifests will always have to be imported as new nodes enter the home domain. For existing nodes, only information that has changed within a virtual collection rather than its entire content is sent. Version vectors may be used in an algorithm for replicating asset metadata across distributed nodes.

The reconcile service acquires the changes to the virtual collection as known on a remote node by interchanging a node version vector. The reconcile service for a node that is initiating reconciliation, per schedule, sends a request for another node's version vector, receives another node's version vector, decodes the node version vector, resolves the differences between its object version vectors and the decoded node version vector it received by requesting updated metadata from the other node, and uses the data access service to update its virtual collection appropriately.

For a node that is responding to version vector requests (while it may also be generating version vectors from modifying its own view), it receives a request for its node version vector, accesses its virtual collection, encodes its node version vector, and sends its encoded node version vector.

The data access service updates object version vectors as changes are made to the content of the virtual collection. The data access service, updates the version vector associated with the object whose metadata has been modified and saves the version vector as an extension of the modified object within the virtual collection.

The user may view at any node at any time a view of the global collection. Since the version vector algorithm is an optimistic replication protocol, at any given instant in time for any two nodes i and j, their databases Dᵢ and Dⱼ, may differ, and so the view presented to the user may differ. However, given enough time, continued connectivity between i and j, and the absence of further updates, Dᵢ and Dⱼ will converge to the same value.

The replication algorithm uses a single version vector to represent the state of each instance of the database. This per-database version vector provides a convenient mechanism whereby nodes can quickly determine if one node needs to synchronize with another node. In addition, the algorithm associates a version vector with each object. Note that a version vector is simply an array of timestamps, where each timestamp is a positive integer. A node's logical time is tracked as an integer value; the node increments its logical timer each time it updates its database.

The algorithm assumes the following:
1. For each node nᵢ containing database Dᵢ, is an associated version vector VVᵢ.
2. The database Dᵢ represents the most current state for each object as known by node nᵢ. Specifically, Dᵢ is an array of quadruples {id(obj), value(obj), vv, ts}, where id(obj) is the globally unique identifier for the object; value(obj) is the object's value, vv is a version vector associated with the object, and ts is the value of VVᵢ[i] at the time the object's value was last updated or added to the node i's database.
b 3. For k=i, VVᵢ[k] represents the current logical time for node i; VVᵢ[i] is incremented before i makes any change to its database Dᵢ.
4. For k≠i, VVᵢ[k] represents the highest logical timestamp for information received from node k, either directly at the point i last synchronized with k, or indirectly, received as the result of synchronizing with some other node.
5. For two version vectors v₁ and v₂ of the same length, v₁<v₂ if and only if for all i, 1≦i≦length(v₁), v₁[i] is not greater than or equal to v₂[i]; and v₁>v₂ if and only if for all i, 1≦i≦length(v₁), v₁[i] is not less than or equal to v₂[i]; v₁=v₂ if and only if for all i, 123 i≦length(v₁), v₁[i]=v₂[i]; otherwise the two version vectors are said to be incomparable.
In other words, one version vector is less than or equal to an another version vector if every element of the first version vector is less than or equal to the corresponding element of the second version vector; having the first version vector be strictly less than the second version vector adds the requirement that at least one element of the first version vector be strictly less than the corresponding element of the second version vector. If two version vectors are incomparable, then the two associated objects were concurrently updated, and their values may conflict. Resolving such conflicts may require user intervention.
6. The version vector associated with each object is maintained as described in the algorithm below; it corresponds to the logical “time” the object was last updated.
7. Each node nᵢ maintains a set of nodes Sᵢ; this represents the current set of nodes nᵢ considers to be part of the system and that it synchronizes with.

To perform a synchronization operation, node i carries out the following:

| | |
|---|---|
| mutexBegin(syncing) | |
| for x = 1 to length(Sᵢ) { | |
| d ← Sᵢ [x] | |
| requestVersionVector(d) | // ask node d for its version vector |
| VV_{d} ← rcvVersionVector( ) | // receive VV_{d} |
| if VVᵢ[d] < VV_{d}[d] then | |
| requestUpdates(d, VVᵢ) | |
| } | |
| mutexEnd(syncing) | |

Note that if VVᵢ[d] is less than VV_{d}[d], then node d has changed its database since node i last communicated with node d. This could happen either because node d has independently updated one or more objects, or because node d has received updates from some other node. The operation is performed within a mutual exclusion block to prevent local updates from occurring during the synchronization process, and to block the node from attempting to synchronize with another node at the same time the node is responding to another node's synchronization request.

The method requestUpdates executes as follows:

```
requestUpdates(d, VVᵢ) {
  sendRequest(d, i, VVᵢ)
  do {
      getUpdate( )
  }while not AllUpdatesReceived and not timedOut
  if allUpdatesReceived {
      // update our complete VV to reflect the updates made by
      other nodes that we
      // received via node d.
      VV_{d} ← rcvVersionVector( )
      for x = 1 to length(VVᵢ) {
          if VV_{d}[x] > VVᵢ[x] then {
              VVᵢ[x] ← VV_{d}[x]
          }
      }
  }
}
```

Method requestUpdates sends a request to node d for updates, specifying that it wants all updates that have occurred since timestamp VV_{d}[i]. It then receives them one update at a time. Once all the updates have been received, the local version vector is updated so that all elements are at least as high as they were in node d's version vector. By performing this update, this node will be able to receive from other nodes only the new updates it needs. However, if the updating process was terminated prematurely, the local node cannot perform this step.

Upon receipt of a message generated by sendRequest, the recipient executes

receiveRequest(recipient, requestor, VV) {
sendUpdates(requestor, VV)
}

The method sendUpdates executed by the recipient performs the following:

```
sendUpdates(requestor, VV) {
  mutexBegin(syncing)
  i ← myId( )  // i here refers to the local recipient node,
  the one sending the updates
  foreach obj in Dᵢ {
      if obj.ts > VV[d] and not (obj.vv ≦ VV) then
          updateSet ← updateSet + obj
      }
  sort(updateSet) // sort by obj.ts
  foreach obj in updateSet {
      sendUpdate(requestor, i, obj)
  }
  sendVersionVector(requestor, VVᵢ)
  mutexEnd(syncing)
}
```

SendUpdates uses a mutex to avoid the complexity of having to manage local updates that occur while past updates are being transmitted. The sender considers only those objects for which obj.ts is greater than the requestor's version vector entry for this node; these are the objects that have potentially changed since the time this node last communicated with the requestor. The purpose of the obj.ts value is to optimize the process of determining the candidate objects that may need to be sent to another node. The timestamp is a simple scalar value, and can be much more efficiently compared than the full version vector.

The sender actually sends to the requester only those objects whose version vector is not less than or equal to the version vector of the requesting node; this keeps the sender from sending data that the receiver has already received from other nodes. The updates are sent in order of their timestamps. This is to ensure that if one or both nodes should crash during the transmission process, and it is subsequently restarted, that no updates are lost. In particular, the recipient's version vector entry for the sender will correspond to the highest update it had received.

To improve performance, sendUpdate may buffer updates and send them in larger groups. Once all the updates have been sent, the node then sends its current version vector. The version vector may have advanced since the time the node had sent its version vector in response to the original request for its version vector.

Updates are received by the method getUpdate, which calls receiveUpdate to read the next transmitted update:

```
getUpdate( ) {
  receiveUpdate(i, d, obj)
  if (obj.id ∉ Dᵢ then
      doUpdateObject(obj, false)
  else if (obj.vv > Dᵢ[obj.id].vv) then
      doUpdateObject(obj, false)
  else if (obj.vv ≦ Dᵢ[obj.id].vv) then
      // continue to use my local value; it's more recent
  else
      // we have a conflict
      status ← resolveConflict(obj)
  VVᵢ[d] ← obj.ts
}
```

Received updates are checked first to make sure they don't conflict with local changes. If the received object's version vector value is strictly greater than the local object's version vector, then the received value is newer; the local node must update its value to that value. By invoking doUpdateObject with the second parameter specified as false, doUpdateObject will preserve the object's version vector. This will keep the node from needlessly sending this object's value out to nodes that already have seen this update. Conversely, if the received object's version vector is less than or equal to the local object's version vector, the local node need not update its copy of the object. Normally this case should not occur, as the sender would typically not attempt to send such objects, but it may occur if one node requests updates from another node after an aborted previous update operation. If the two version vectors are not comparable, then the values conflict, and the conflict must be resolved using a conflict resolver. The function resolveConflict attempts to resolve the conflict either automatically or via user intervention.

```
resolveConflict(obj) {
  if conflictIsResolveable(obj) then
      obj.vv ← pairwiseMax(obj.vv, Dᵢ[obj.id].vv)
      doUpdateObject(obj, true)
      return true
  else
      return false
}
```

If the conflict is resolvable, then the version vector is set to be the pairwise maximum of the two version vectors, with the entry in the version vector for this node subsequently getting incremented, so that the resolved value will be propagated to other nodes.

The actual update is performed by doUpdateObject:

```
doUpdateObject(obj, updateObjVV) {
  VVᵢ[i]++
  if (obj ∈ Dᵢ) then
      Dᵢ[id].value ← obj.value
      Dᵢ[id].vv ← obj.vv
      Dᵢ[id].ts ← VVᵢ[i]
  else
      Dᵢ ← Dᵢ ∪ {obj.id, obj.value, obj.vv, VVᵢ[i]}
  if (updateObjVV) then
      Dᵢ[id].vv ← VVᵢ[i]
}
```

The local nodes timestamp VVᵢ[i] is always incremented, and the object's timestamp is always set to this value. The object's version vector may or may not be updated, depending upon the value of the flag updateObjVV. If the database is simply being updated with the value of an object received from another node, then the object's version vector is not updated—the node simply preserves the associated version vector. To do otherwise would result in this object being perceived as having been updated by a local change—one that had to be propagated back to other nodes including the one that sent the changed value. However, if the update is the result of a conflict resolution, then the version vector is updated.

Local updates are handled by

```
localUpdateObject(obj) {
    mutexBegin(synching)
    VVᵢ[i]++
    Dᵢ[id].value ← obj.value
    Dᵢ[id].vv ← VVᵢ
    Dᵢ[id].ts ← VVᵢ[i]
    mutexEnd(synching)
}
```

The algorithm is deliberately one way in nature; for a complete synchronization between two nodes to occur, each node would run the algorithm separately. When a node becomes reconnected to a network of other nodes, it must contact each other node to obtain all pending updates. For consumer imaging applications, the number of nodes is likely to be small, and so this is not expected to be a significant issue.

Conflicts may arise if the user updates the same asset on two different nodes and the system is unable to run this protocol in between the updates. In such cases, the conflict will be detected when the algorithm is run. Note that we could have associated with each asset's metadata field a separate version vector, instead of just having a single version vector for the asset. If the system kept track of versions at the metadata level, users would be able to update different metadata items for the same asset without causing a conflict.

Although version vectors have been used extensively in message passing systems and in implementing replicated databases, they have not yet been widely adopted for peer-to-peer file sharing. This algorithm uses version vectors to provide the end-user with location-transparent access to their content. Users may access and manage their content from their home media server, their wireless camera or other portable device, or through an online service. Although users may not always have access to high resolution asset renditions, this approach allows the user to perform the common operations of browsing, navigating and organizing their collection, and view low resolution renditions of assets that the system implementer or user has chosen to replicate.

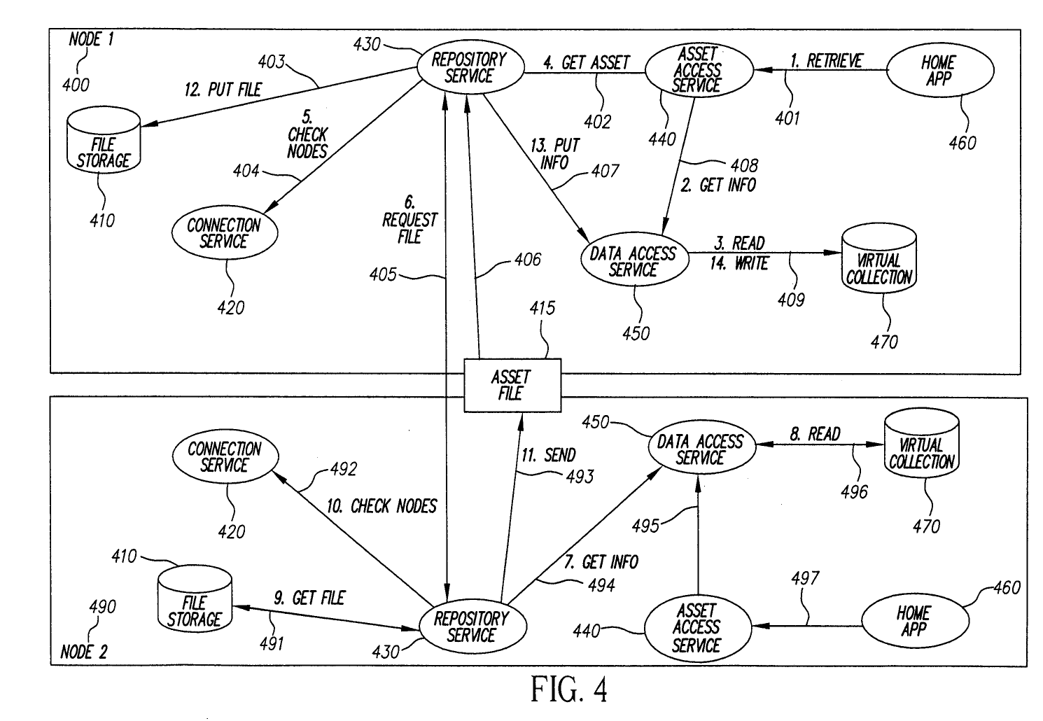

FIG. 4 depicts the GAM components that interact and the sequence of messages that are exchanged in order to realize digital asset manipulation and movement between nodes (i.e., a retrieve operation).

The application running on a node in a user's home environment must be able to retrieve, update, store, and copy digital assets regardless of the node on which the corresponding files reside. An asset access service 440 accepts requests from the application 460 to perform operations on digital assets which include: retrieve in order to edit or print (message 401), update after an edit and save, store after an add or an edit and save as, copy, controls the logic around the use of the data access service on the user's application (messages 408-409), locates some renditions of digital assets in the virtual collection, and uses the repository service 430 for renditions of digital assets located outside of the virtual collection 470. The repository service 430 provides access to the inventory of digital assets located on storage servers. It also represents the component on the receiver node that may need to remotely satisfy a request for a digital asset. The repository service 430, for a node that is initiating digital asset management, accepts requests to manage a digital asset (message 402), satisfies some requests (i.e., retrieve, update, store) on the user's application node, and satisfies other requests (i.e., retrieve, copy) by accessing another node in the home environment (messages 404-405).

If the digital asset file is received from another node, the repository service stores the asset file and updates its virtual collection (messages 403,409).

For a node that is responding to a digital asset management request, it accepts requests to manage a digital asset, finds the digital asset (messages 494, 405, 491), and transfers the digital asset file to requesting nodes (messages 492-493). The repository service is used by the archive, backup, and restore services to support their movement of digital assets within and between nodes.

A node needs to send requests to and receive replies from other nodes during reconciliation and asset movement. A message abstraction layer decouples the responsibility for understanding transmission specifics from the reconcile service and repository service. A message abstraction layer can then adapt its transmission binding to the format and protocol required for inter-node communication (e.g., socket, FTP, web service). The message service, transmits requests on behalf of a sending node that wants to interchange content with other nodes and receives messages on behalf of a receiving node that must return the requested content.

Any given node will understand its own properties, but will discover the other nodes in its domain and request their profiles dynamically. The connection service recognizes information about the nodes via a profile. A node profile is an entity in the metadata model and is interchanged upon request. A node profile defines static properties known, a priori, only by the node. These properties include services and capabilities (e.g., storage node with a manifest) and how to contact it (e.g., protocol, credentials).

The GAM system may incorporate several areas within security including global user accounts, access control (i.e., privileges) to digital assets across users and groups, and protection of interchange information as it moves between nodes.

Event services provide for archive and backup/restore functions. Backup and archive operations will make copies of database and digital assets as a safeguard against system failure, to free up space, or other reasons.

ARCHIVING refers to the act of moving a digital asset to some reliable probably “offline” storage media in order to insure that a copy of the asset will be permanently available throughout time. The asset can be retrieved at some later time, an operation that usually requires a special operation and often manual user intervention. The location of offline assets will be permanently tracked in the asset database. Any archived asset's information will be retained even if the asset in question is superseded by another version. Archiving operations can span nodes. A user can move an archived asset back into the system via explicit action from within the application.

In contrast, BACKUP will make a copy of some part of a user's collection (both database and repository contents) for the specific purpose of recovering the collection following a system failure. It is, in effect, a “snapshot” of a node at a given point in time. Assets in a backup set will not be accessible for normal operations, whereas archived assets may be retained in their original context. Since a user's collection can span several nodes, backing up an entire collection will be a daunting exercise. Therefore, backup will operate on a node-by-node basis. However, by the use of “auto-copy,” users will be able to set their system up so that a single, resource-rich node can serve as a collection point for all assets. Backing this node up will have the effect of backing up a user's entire collection. Users will be able to select backup intervals, full or incremental backup, and backup scope based on standard organization schemes supported by GAM and the backup device. A backed up asset (database content or digital asset) will have its last backup time and date recorded in the GAM database. Following a backup, a RESTORE operation will copy the backup set over any GAM information on the target node, restoring it to its exact state at the time of backup.

It is also to be understood that the present invention is not limited to the particular illustrated and that various modifications and changes may be made without departing from the scope of the present invention, the present invention being defined by the following claims.

### PARTS LIST

10—User's Media Ecosystem
20—User's Home Media Environment
21—Television
22—Laptop Computer
23—Printer
24—Office PC
25—Media Box
30—Online Photo Service
40—Mobile Devices
41—Digital Camera
42—Phone Cam
100—System Architecture
110—Online Services
111—Asset Collection Database
112—Asset Repository
113—GAM Services
120—Home System
130—Consumer Handheld Device
131—Asset Cache
140—Retail Services
150—Back Office Support
160—Basic Services
170—Premium Services
180—Metadata Interchange Schema
300—Node 1
301—Reconcile view
302—Check nodes
303—Request manifest
304—Create and send manifest
305—Change view
306—Data access request
307—Virtual collection update
310—Connection Service
320—Reconcile Service
330—Data Access Service
340—Home Application
350—Virtual Collection
360—Collection Manifest
370—Node 2
371—Connection Service request
372—Create and Send manifest
373—Get view request
374—Virtual collection update
375—Change view request
376—Reconcile request
400—Node 1
401—Retrieve request
402—Get asset
403—Put file
404—Check Nodes request
405—Request file
406—Asset file receive
407—Put info
408—Get info request
409—Access/Update Virtual collection
410—File Storage
420—Connection Service
430—Repository Service
440—Asset Access Service
450—Data Access Service
460—Home Application
470—Virtual Collection
480—Asset file
490—Node 2
491—Get file request
492—Check nodes request
493—Send asset file
494—Get Info request
495—Get Info request
496—Read Virtual Collection Request
497—Asset access request

1. A system for managing assets of a user in a network, comprising: a plurality of nodes each having an identical manifest, the manifest having an entry for said asset, the entry describing metadata about the asset and an organization and a location of each asset.

2. The system of claim 1, wherein the plurality of nodes are coupled in a communication network.

3. The system of claim 1, wherein a node comprises a device in the home environment, an online photo service, or a mobile device.

4. The system of claim 3, wherein a device in the home environment comprises a television, personal computer, printer, or a media box.

5. The system of claim 1, wherein assets comprise still images, videos, audio, or multimedia presentations.

6. A method for updating manifests of a plurality of nodes provided on a network, each of the manifests having an entry for each asset owned by a user, said entry describing metadata about said asset and an organization and a location of each asset, comprising the steps of:
establishing a communication connection from a first node to a second node,
providing from said second node, the version vector of its manifest,
providing from said second node manifest updates,
modifying the manifest of the first node with said second node manifest updates.

7. A method of claim 6, wherein the plurality of nodes are coupled in a communication network.

8 A method of claim 6, wherein a node comprises a device in the home environment, an online photo service, or a mobile device.

9 A method of claim 8, wherein a device in the home environment comprises a television, personal computer, printer, or a media box.

10. A method of claim 6, wherein assets comprise still images, videos, audio, or multimedia presentations.

11. The method of claim 6, wherein the first and second node's manifests include additional version vectors associated with each entry, and where said version vectors are used to determine which updates from said second node's manifest should be applied to the first node's manifest.

12. The method of claim 6, wherein each node's manifest additionally contains distinct entries for one or more metadata items associated with each asset, and wherein a version vector is associated with each entry, and where said version vectors are used to determine which updates from said second node's manifest should be applied to the first node's manifest.

13. A method of claim 6, wherein said version vector compared with the version vector of the first node to determine if the first node's manifest needs to be updated.
